(19) United States
(12) Patent Application Publication
(10) Pub. No.: US 2018/0257069 A1
(43) Pub. Date: Sep. 13, 2018

(54) DYNAMIC MICROFLUIDIC DEVICES AND USE THEREOF

(71) Applicant: TECHNION RESEARCH & DEVELOPMENT FOUNDATION LIMITED, Haifa (IL)

(72) Inventors: Moran BERCOVICI, Haifa (IL); Shimon RUBIN, Haifa (IL); Amir GAT, Haifa (IL)

(21) Appl. No.: 15/760,048

(22) PCT Filed: Sep. 15, 2016
(86) PCT No.: PCT/IL2016/051030

§ 371 Date: Mar. 14, 2018

Related U.S. Application Data
(60) Provisional application No. 62/219,150, filed on Sep. 16, 2015.

(51) Int. Cl. B01L 3/00

(52) U.S. Cl. CPC B01L 3/5027; B01L 2300/0645; B01L 2400/0454; B01L 2300/0887; B01L 2300/123; B01L 2300/0816

(57) ABSTRACT

The present invention is directed to, inter alia, a device comprising an actuation chamber and a configurable plate device suitable for analysis and separation of samples of interest. A method of use the disclosed device for the detection and/or separation of molecules of interest, is provided.

This application claims the benefit of priority from U.S. Provisional Patent Application No. 62/219,150, filed on Sep. 16, 2015. The content of the above document is incorporated by reference in its entirety as if fully set forth herein.

### FIELD OF INVENTION

The present invention is in the field of microfluidic devices and assays.

### BACKGROUND OF THE INVENTION

The interaction and communication between individual cells plays a central role in virtually all fields of biology, from the cooperative work of cells in the immune system, through the differentiation of stem cells, and to the proliferation of cancer cells. In recent years, it has been shown that these processes are fundamentally coupled to cell-to-cell heterogeneity and variability, which manifests itself in all cell functions, from the level of the genome, transcriptome, and proteome, to the level of proliferation, migration, differentiation and apoptosis. Studying cellular ensembles masks these differences, and may yield observations that are not representative of any individual cell type or subpopulation. Despite this, most current studies consider cell populations, largely due to technological limitations in the ability to dynamically compartmentalize, manipulate, and analyze single cells.

In the past decade, there has been development in high-throughput methods of single-cell analysis (Zare, R. N.; Kim, S. Annu. Rev. Biomed. Eng. 2010). Tools developed include various microfluidic chips for individual (Anderson, J.; Quake, S. R. Anal. Chem. 2006) or paired (Skelley, et al., J. Nat. Methods. 2009) cell capture and analysis, droplet microfluidics (Brouzes, E. et al., Proc. Natl. Acad. Sci. U.S.A. 2009), digital microfluidics (Barbulovic-Nad, I. et al., Lab. Chip. 2008, 8, 519), FACS and microFACS (Cho, S. H. et al., Lab. Chip. 2010). Particularly notable is the use of on-chip pneumatic valves enabling elaborate multi-step protocols to be performed (Unger, M. A. et al., Science, 2000). These tools have reduced time necessary for hands-on work, and allowed for work at previously unattainable single-cell scales, enabling fundamental discoveries in all aspects of biology (Zare, R. N.; Kim, S. Annu. Rev. Biomed. Eng. 2010).

Existing high-throughput analysis technologies are based on one-time rigid confinement of reactants and/or cells (whether by droplets, micro-wells, or valves) and are not well-suited for dynamically joining, separating, or reconfiguring reaction chambers. As a result, important questions such as in cellular behavior remain beyond the reach of existing tools. More fundamentally, though, many of the high-throughput analysis technologies do not allow the flexibility and real-time experimental decision-making essential to scientific work. After carrying out a predetermined protocol, it is rarely possible to perform unplanned follow-up experiments on the specific reaction chambers or on the same system, based on the obtained results. Rapid progress in research depends on the ability to make real-time experimental decisions, in which the observations from the current step direct subsequent steps in the experiment—a level of flexibility unattainable with current tools.

### SUMMARY OF THE INVENTION

The present invention provides, in some embodiments thereof, a device comprising a dynamically deformable plate and a method of use thereof, including, but not limited to the study and characterization of cellular networks or cell-cell interactions.

According to one aspect, there is provided a device comprising: a chamber comprising an actuation medium; an electrode layer comprising at least one electrode, and a dynamically configurable layer, wherein the at least one electrode is configured to induce a predetermined and variable pressure on at least a portion of the dynamically configurable layer, and wherein the configurable layer is configured to deform responsively to the pressure.

In some embodiments, the device is in the form of a multiple stacked layers, the device comprising an actuation layer comprising the electrode layer actuation medium and a dynamically configurable layer.

In some embodiments, the electrode layer is deposited on or incorporated in at least a portion of the dynamically configurable layer.

In some embodiments, at least a portion of the electrode has one or more layers of dielectric material deposited thereon.

In some embodiments, the actuation medium is in fluid communication with the dynamically configurable layer.

In some embodiments, the actuation medium is in fluid communication with the actuation layer and the dynamically configurable layer.

In some embodiments, the electrode is selected from the group consisting of platinum, gold, silver, aluminum, titanium, antimony, bismuth, carbon, iridium, zinc oxide, and indium tin oxide (ITO), or any combination thereof.

In some embodiments, the electrode is a light pattern electrode.

In some embodiments, the actuation layer comprises chemically patterned layer.

In some embodiments, the actuation medium comprises a Newtonian liquid.

In some embodiments, the actuation medium comprises a non-Newtonian liquid.

In some embodiments, the non-Newtonian liquid comprises a material selected from the group consisting of Poly(acrylic acid) (PAA), carboxymethyl cellulose (CMC), or a combination thereof.

In some embodiments, the dynamically configurable layer is an elastic membrane characterized by E*h³ having a value between 10⁻¹³ to 10⁻⁹ N*m, wherein “E” is Young's modulus of the membrane, and “h” is a thickness of the membrane.

In some embodiments, the dynamically configurable layer has a thickness of less than 500 μm.

In some embodiments, the dynamically configurable layer is an elastic membrane comprising a polymer selected from the group consisting of: poly(dimethylsiloxane) (PDMS), low density Poly(ethylene) (LDPE), Poly(vinyl chloride) (PVC), and Poly(imide), or a combination thereof.

In some embodiments, the device further comprises a liquid atop the dynamically configurable layer, the liquid is configured to allow loading biological samples therein.

In some embodiments, the device further comprises a ceiling comprising one or more materials selected from glass, polymer, PDMS, Silicon, epoxy, acrylic, and Teflon.

In some embodiments, the device further comprises a spacer being disposed at a distance that ranges from 1 to 100 μm from the actuation layer, and being in fluid communication with the actuating medium.

In some embodiments, the distance ranges from 1 to 50 μm from the actuation layer.

According to an aspect of some embodiments of the present invention, there is provided a system comprising the device in some of any embodiments thereof.

In some embodiments, the system further comprises one or more probing tools selected from: a microscope, a photodetector, a photomultiplier tube (PMT), a conductivity detector, a point detector a radioactive detector, a camera, and any combination thereof.

In some embodiments, the system further comprises a control unit configured to induce a predetermined and variable pressure on at least a portion of the dynamically configurable layer so as to deform in response to the pressure.

According to an aspect of some embodiments of the present invention, there is provided a method comprising the steps of: providing the disclosed device in some of any embodiments thereof, and establishing a kinetic process on at least a portion of the dynamically configurable layer, so as to provide pressure distributions on a surface thereof, the deformation comprising one or more spatial gradient regions.

According to an aspect of some embodiments of the present invention, there is provided a of sample analysis, the method comprising the steps of providing a device comprising an actuation layer; an actuation medium, and a dynamically configurable layer; placing a sample to be analyzed on a surface of the dynamically configurable layer, and establishing a kinetic process on the actuation medium so as to deform the surface, wherein the deformation of said surface comprises one or more spatial gradient regions.

In some embodiments, the step of establishing a kinetic process is induced by at least one electrode layer having one or more layers of dielectric material deposited thereon.

In some embodiments, the sample is selected from a biological content selected from a single cell, a population of cells, cell extract, tissue sample, blood sample, urine sample, sputum sample, cerebrospinal fluid, viruses, virus particles, protein, DNA, RNA or metabolites.

In some embodiments, the kinetic process is an electrokinetic process comprising a step of applying an electric field so as to induce the pressure gradients on the surface.

In some embodiments, the kinetic process is driven by one or more from group consisting of: electroosmosis, dielectrophoresis (DEP), and an electrostatic force.

In some embodiments, the electroosmosis is induced charge electroosmosis (ICEO).

In some embodiments, the method further comprises one or more steps selected from isolating one or more biological cells and/or constructing networks between cells of interest, on the configurable membrane.

In some embodiments, the method further comprises one or more steps of performing a biological assay.

In some embodiments, the biological assay is selected from: enzymatic assay, a binding assay, nucleic acid hybridization, Polymerase Chain Reaction (PCR), electrophoresis, liquid chromatography, cell activation, cell migration, cell separation, cell quantification, proteomic analysis, genomic analysis, DNA sequencing, microorganism detection, viral detection, DNA/RNA microarray, and immuno-assay.

In some embodiments, the method further comprises a step of labeling the samples.

In some embodiments, the method further comprises a step of probing the samples.

In some embodiments, probing is achieved by using a photodetector, a photomultiplier tube (PMT), a conductivity detector, a point detector a radioactive detector, a camera, or any combination thereof. In some embodiments, the probing comprising tracing one or more optical signals.

According to an aspect of some embodiments of the present invention, there is provided a device comprising: a chamber comprising actuation medium; a chemically patterned layer; and a dynamically configurable layer, wherein the chemically patterned layer is configured to induce a predetermined and variable pressure on at least a portion of the dynamically configurable layer, and wherein the configurable layer is configured to deform responsively to the pressure, and wherein the device is configure to be operably link to at least one electrode.

In some embodiments, the chemically patterned layer is deposited on at least a portion of the deformable plate.

In some embodiments, the chemically patterned layer is deposited on at least a portion of the actuation medium. In some embodiments, the chemically patterned layer comprises a light pattern electrode.

According to an aspect of some embodiments of the present invention, there is provided a method comprising the steps of:

providing the device comprising: a chamber comprising actuation medium; a chemically patterned layer; and a dynamically configurable layer, and

establishing a kinetic process on at least a portion of the dynamically configurable layer, so as to provide pressure distributions on a surface thereof, the deformation comprising one or more spatial gradient regions.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Exemplary embodiments are illustrated in referenced figures. Dimensions of components and features shown in the figures are generally chosen for convenience and clarity of presentation and are not necessarily shown to scale. The figures are listed below.

FIGS. 1A-B show a schematic illustration of an exemplary device (FIG. 1A) and a 3D perspective view an exemplary simplest setup of the device (FIG. 1B);

FIGS. 2A-B show a schematic illustration in 2D (FIG. 2A) and a schematic illustration of perspective view in 3D (FIG. 2B) of an exemplary device, according to some embodiments described hereinbelow;

FIGS. 3A-C show schematic illustration of the simplest setup (FIG. 3A), analytical results, showing the resulting hydrostatic pressure values (grayscale) accompanied by the corresponding streamlines (white) (FIG. 3B), analytical results showing the deformation that can be obtained when the upper wall is replaced with a thin deformable membrane, and the required surface potential on the bottom rigid plate (colormap) (FIG. 3C); and

FIGS. 4A-I present data showing an initial library of elements that could be implemented on the disclosed chip: two overlapping Gaussians can be used to create a narrow gap (narrower than the electrode resolution) for trapping flowing cells (FIG. 4A); a closed chamber for holding cells in a confined region without interaction with the environment (FIG. 4B); a large chamber allowing cell culturing, together with a narrow microchannel for potential connection with other chambers (FIG. 4C); all elements can multiplexed to create arrays of cell traps and confinements (FIGS. 4D-E); cells residing in separate chambers can be dynamically connected to allow or block chemical interaction between the cells (FIG. 4F); two examples of traveling waves (vertical and planar) can be produced to implement fluid transport via peristaltic pumping (FIG. 4G-H). A diffusive cell trap used to hold a cell in place, while allowing diffusive communication with its neighbors (FIG. 4I).

### DETAILED DESCRIPTION OF THE INVENTION

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

The Device

The present invention is, inter alia, directed to a device comprising an actuation chamber and a configurable layer.

The present invention provides, in some embodiments thereof, a device (also referred to hereinthroughout as “chip” or “device 100”) being in the form of multiple stacked layers (also referred to as “sandwich structure”), the device comprising an actuation layer, comprising an electrode layer (e.g., in the form of “electrode array”) comprising at least one electrode, wherein at least a portion of the electrode has one or more layers of dielectric material deposited thereon; actuation medium, and a dynamically configurable layer.

Optionally, the at least one electrode is configured to induce a predetermined and/or variable pressure on at least a portion of the configurable layer, such as, via the actuation medium, and wherein the configurable layer is configured to deform responsive to the pressure.

The term “variable pressure” indicates a condition in which the pressure varies during a time period and/or along a defined surface.

Optionally, the actuation medium is or comprises a liquid as described hereinthroughout.

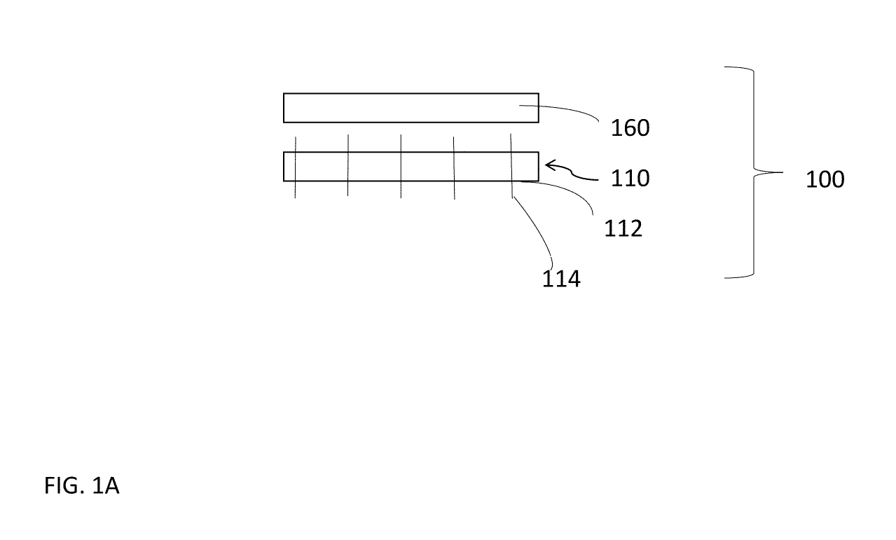

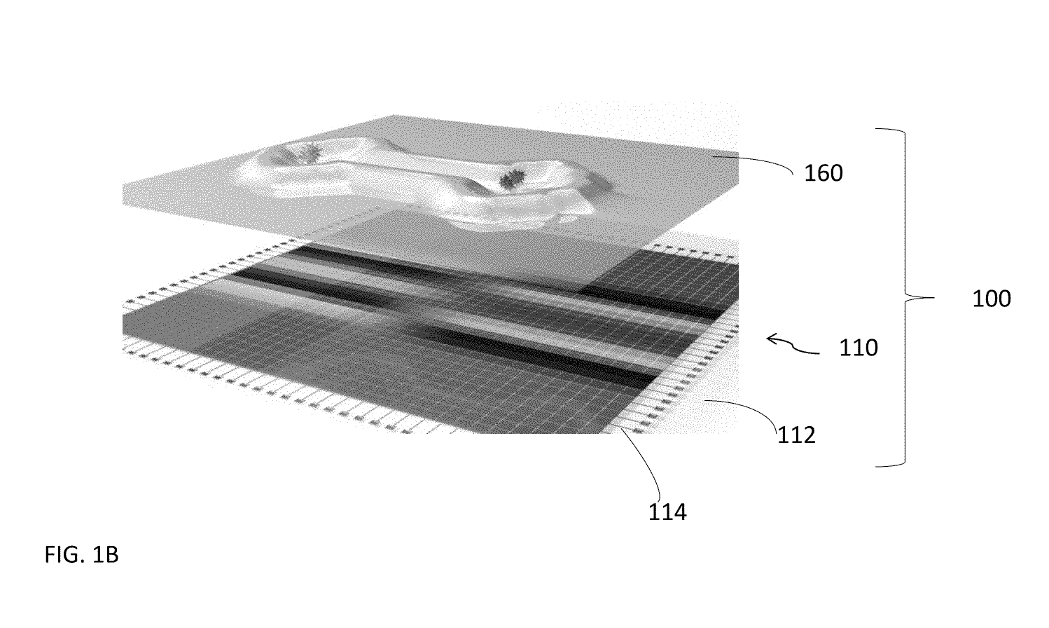

Reference is now made to FIGS. 1A-B, which show a perspective view and a 3D illustration, respectively, of an exemplary device 100.

Device 100 may have a housing. The housing may fully encapsulate elements of device 100 and may be made of a rigid, durable material, such as aluminum, stainless steel, a hard polymer and/or the like. The housing may partially encapsulate elements of device 100. The housing may prevent unwanted foreign elements from entering device 100.

Device 100 may have actuation chamber 110. Embodiments of actuation chamber 110 are described and exemplified hereinbelow. Actuation chamber 110 may have an actuation layer 112, as described and exemplified hereinbelow. Device 100 may have a deformable plate 160 as described and exemplified hereinbelow.

Actuation chamber 110 (or actuation layer 112) may have an array of electrodes 114 as described and exemplified hereinbelow. Alternatively, or additionally, array of electrodes 114 may be deposited on, or incorporated in, deformable plate 160.

Electrodes 114 may have one or more dielectric materials deposited thereon.

Under an applied electric field, electrodes 114 may cause pressure gradients, which deform the deformable plate 160 into predetermined shapes.

As illustrated in FIG. 1B, the top chamber is a cellular workspace, which is electrically insulated from the actuation chamber by the membrane.

As further discussed hereinbelow, the chip is able to dynamically implement reaction chambers (e.g., cell traps), isolated or diffusive chambers, connecting channels, pumps, and other fundamental structural and functional elements. For a non-limiting example, after capturing a cell, a cell-trap could completely disappear and give rise to a large confining chamber. After a desired incubation time, this chamber may then be connected by a dedicated channel to a neighboring chamber, and liquid could be pumped from one to the other.

The term “chamber”, as used herein, means a natural or artificial enclosed space or cavity known to those of skill in the art. By “enclosed”, it is further meant to refer to at least partially enclosed.

The term “actuation” relates to the capability of causing or supporting a mechanical action or motion.

The terms “configurable layer”, “dynamically configurable plate layer”, “configurable plate”, and “deformable plate” are used herein interchangeably and refer to a plate capable of being in a motion and is capable of having its surface (or subsurface) shape altered due to an application of a pressure (e.g., stress). Optionally, the plate can substantially return to its original shape after the pressure is no longer applied.

The term “deformation” generally includes within its scope one or both of a plastic deformation and an elastic deformation. In some embodiments, the term “deformation” relates to predetermined deformation zones or grooves in and/or on the plate. As used herein, the term “predetermined” means chosen to affect a desired result (e.g., deformation structure), as opposed to being random.

By “dynamically” it is meant to refer to a predetermined topological or deformation structure being constant, variable, and/or reversible.

As used hereinthroughout, the term “fluid communication” means fluidically interconnected, and refers to the existence of a continuous coherent flow path from one of the components of the system to the other if there is, or can be established, liquid and/or gas flow through and between the ports, when desired, to impede fluid flow therebetween. In some embodiments, this term refers to a direct contact of the actuation chamber and the deformable plate, e.g., a direct contact of the deformable plate with the actuation layer, or a direct contact of the deformable plate with the spacer as described hereinbelow.

The term “sandwich structure” refers to an essentially layered arrangement of actuation chamber and a configurable (deformable) plate.

The term “substantially parallel” means that the axes of at least part of the actuation liquid and deformable plate are parallel within a range of less than ±30 degrees.

An actuation layer of the device described herein may be of solid or semi-solid substrates.

In some embodiments, the actuation layer comprises an array of electrodes.

Herein, the term “array of electrodes” may refer to a single electrode or a plurality of electrodes. The terms “electrodes”, “array of electrodes” or “arrangement of electrodes” do not necessarily refer to any specific geometric arrangement of electrodes.

As used herein and in the art, the term “electrode” means an electric conductor through which a voltage potential can be measured. An electrode can also be a collector and/or emitter of an electric current. In some embodiments, an electrode is a solid and comprises a conducting metal.

In some embodiments, the electrode is a light pattern electrode. One skilled in the art will recognize that the term “light pattern electrode” may encompass various types of electrodes e.g., as described e.g., in Chiou et al., Nature, Vol. 436, 2005.

In some embodiments, conducting metals include noble metals, alloys and particularly stainless steel and tungsten. An electrode can also be a microwire, or the term “electrode” can describe a collection of microwires.

Herein, the term “array of electrodes” may refer to a single electrode or a plurality of electrodes. The terms “electrodes”, “array of electrodes” or “arrangement of electrodes” do not necessarily refer to any specific geometric arrangement of electrodes.

Non-limiting exemplary electrodes are selected from carbon, gold, silver, nickel, zinc oxide, antimony, bismuth, carbon, iridium, zinc oxide, and platinum. In exemplery embodiments, the electrodes are selected from Pt-Ti and indium tin oxide (ITO).

Optionally, the array of electrodes have deposited on at least a portion thereof one or more layers of dielectric material.

Optionally, the array of electrodes is insulated by a layer of a polymer. In some embodiments, the polymer is selected from, without being limited thereto, parylene and PDMS.

By “a portion” it is meant to refer to, for example, a surface or a portion thereof, and/or a body or a portion thereof, of solid or semi-solid substrates (layers); or a volume or a part thereof. In some embodiments, by “a portion ” as used herein throughout, it is meant e.g., at least 1 percent, at least 20 percent, at least 30 percent, at least 40 percent, at least 50 percent, at least 60 percent, at least 70 percent, at least 80 percent, at least 90 percent, and optionally all of the surface is coated, as feasible, including any value therebetween.

The term “dielectric” (or “dielectric materials”) refers to the broad expanse of nonmetals considered from the standpoint of their interaction with electric, magnetic, or electromagnetic fields such that the materials are capable of storing electric energy. A dielectric material is a substance that is a poor conductor of electricity, but an efficient supporter of electrostatic fields. If the flow of current between opposite electric charge poles is kept to a minimum while the electrostatic lines of flux are not impeded or interrupted, an electrostatic field can store energy.

Optionally, the electrode is embedded within the actuation layer. In some embodiments, the electrodes are external to the substrate. Typically, but not exclusively, two or more electrodes may be used, such as in the form of channel network(s).

In some embodiments, the actuation liquid is a Newtonian liquid (fluid). As used herein and in the art, Newtonian liquid is a fluid in which the viscous stresses arising from its flow, at every point, are linearly proportional to the local strain rate—the rate of change of its deformation over time. In some embodiments, the actuation liquid is a non-Newtonian liquid (fluid).

Exemplary non-Newtonian liquids are selected from, but are not limited to, Poly(acrylic acid) (PAA), carboxymethyl cellulose (CMC), or a combination thereof.

In some embodiments, the actuation liquid comprises both a Newtonian fluid and a non-Newtonian fluid.

In some embodiments, the configurable plate is an elastic membrane characterized by E*h³ having a value e.g., below 10⁻⁵, wherein: “E” is Young's modulus of the membrane, and “h” represents at least one dimension of the membrane. In some embodiments, the dimension is a thickness of the membrane.

In some embodiments, E*h³ has a value of e.g., 10⁻⁸, 10⁻⁹, 10⁻¹⁰, 10⁻¹¹, 10⁻¹², 10⁻¹³, or 10⁻¹⁴, including any value and range therebetween.

In some embodiments, the configurable layer (also termed herein deformable plate) is an elastic membrane e.g., an elastomeric polymer. In some embodiments, the membrane comprises a polymer characterized by Young's modulus of less than e.g., 1 MPa, 900 kPa, 800 kPa, 700 kPa, 600 kPa, 500 kPa, 400 kPa, 300 kPa, 200 kPa, 100 kPa, 90 kPa, 80 kPa, 70 kPa, 60 kPa, 50 kPa, 40 kPa, 30 kPa, 20 kPa, 10 kPa, or 1 kPa, including any value therebetween.

Typically, but not exclusively, membrane characterized by high modulus of e.g., 1 MPa dictates thin thickness, e.g., 10 μm. In some embodiments, the thickness of the membrane is 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1000 μm, or 2 mm, including any value therebetween.

As used herein and in the art, the term “Young's Modulus” refers to a quantification of the elasticity of a given material (also referred to as “stiffness”). Young's modulus, E, can be calculated by dividing the tensile stress by the tensile strain.

Relevant elastomeric polymers in the context of the present disclosure include, but are not limited to, polysiloxane e.g., polydimethylsiloxane (PDMS), polybutadiene, silicone rubber, Poly(imide) e.g., kapton, polycarbonate polyurethane, epoxy, polyacrylate, polyethylene e.g., low density Poly(ethylene) (LDPE), Poly(vinyl chloride) (PVC), and any copolymer and/or derivative thereof. The term “copolymer” as used herein throughout means a polymer of two or more different monomers. In exemplary embodiments, the elastomeric polymer is PDMS.

Optionally, the device further comprises a liquid (also referred to as “working liquid”) atop the deformable plate. Herein “working liquid” may further encompasses a gel.

The deformable plate may promote creating a microstructure thereon.

The term “atop” as used herein is not restricted to a particular orientation with respect to the gravitational field of the local environment, but simply refers to one element being disposed on another element, optionally with one or more intermediate elements disposed therebetween, unless otherwise indicated. Thus, a first element may be “atop” a second element even if the first element is disposed on a “bottom” (from the standpoint of gravity) surface of the second element.

In some embodiments, the deformable plate has deposited on a portion thereof a chemically patterned layer. In some embodiments, the actuation layer has deposited on a portion thereof a chemically patterned layer. In some embodiments, the actuation medium has deposited on a portion thereof a chemically patterned layer.

The term “chemical patterning” refers to the creation of a geometric or topological pattern of chemical entities or groups on a surface, or in a three-dimensional material.

In some embodiments, creation of a geometric or topological pattern refers to pattern configuration, on at least a portion of the surface.

In some embodiments, the chemically patterned layer is a self-assembled material.

In some embodiments, the oriented chemically patterned layer is a monolayer.

In some embodiments, the chemically patterned layer comprises pre-coated surface.

Exemplary chemically patterned layers include, without being limited thereto, functionalized glass surface (e.g., glass surface functionalized with alkoxysilane such as 3-Aminopropyl)triethoxysilane (APTES), and functionalized epoxy or aldehyde coated surface (e.g., functionalized with nucleotide such as DNA molecule).

In some embodiments, the chemically patterned layer comprises a light pattern electrode.

In some embodiments, the pre-coated surface comprises an etched region. In some embodiments, one or more distinguishable features at the nanoscale or microscale are oriented in a predictable manner relative to one another.

In some embodiments, the chemically patterned layer is deposited on at least a portion of the deformable plate.

In some embodiments, the chemically patterned layer is deposited on at least a portion of the actuation medium.

In some embodiments, one or more features are distinguishable at the macroscopic (visible light) length scale.

In some embodiments, chemical patterning layer is deposited by a process including, without limitation, chemical vapor deposition (CVD), plasma enhanced CVD, atomic layer deposition (ALD), sputtering, silanization, thermal evaporation, electron beam evaporation, pulsed laser deposition, spin coating or other suitable deposition method that is compatible with the processes and equipment used in the art.

In some embodiments, “chemical patterning” refers to photochemical method permitting the covalent attachment of active functional group onto solid surface under gentle reaction conditions.

In some embodiments, photochemical process may be induced by a defined wavelength or a laser.

In some embodiments, chemical patterning refers to light-induced activation of surface molecules. In some embodiments, chemical patterning refers to light-induced removal of molecules. In some embodiments, chemical patterning is based on a compound having at least one functional groups e.g., a photoactivable group.

In some embodiments, chemical patterning refers to a defined surface density of the light-activated molecules. In some embodiments, chemical patterning correlates to light density per unit area.

The chemical pattern layer, includes but is not limited to, and is capable of, self-organizing into nanometer-scale patterns.

Materials creating the desired characteristics for the configuration control portion may include: a cross linked organic polymer including an epoxy-based homopolymer or copolymer; a surface modified organic homopolymer or copolymer; a self-assembled monolayer, a polymer brush-modified layer, or a cross-linked organosilicate; random copolymer brushes, random cross-linked copolymers, or mixtures of polymer brushes or cross-linked polymers, block copolymers, block terpolymers, homopolymers, DNA, and blends of these polymers, or even a properly and precisely oxidized silicon surface. In some embodiments, the materials comprise one or more charged molecules. In some embodiments, the charged molecules bind the materials to the substrate (e.g., the deformable layer) at a desired location and/or pattern.

Polymer brushes can provide a configuration control surface, in which the surface is reactively modified to the desired thickness and surface properties using polymeric brush precursors with a desired composition.

In some embodiments, photo-patternable pattern, is based on random copolymers with an appropriate functional monomer, for example, and without limitation, monomers having azide, glycidyl or acryloyl groups.

In some embodiments, photo-patternable pattern is based on molecular manipulator that comprises a light-sensitive molecule. In some embodiments, the molecules include a double bond that changes its cis-trans configuration in response to illumination by a selected wavelength of light (e.g., in the U.V. range).

In some embodiments, the chemical patterning refers is charge (positive or negative) induced layer which may be controlled e.g., by applying electric field as described hereinthroughout.

Optionally, the disclosed device is in the form of an integrated lab-on-a-chip e.g., for carrying out a chemical or biological assay for detection of a chemical or biological molecule, respectively, or for determining one or more characteristics of a sample. The term “lab-on-chip” means an integrated chip on which various scientific operations such as reaction, separation, purification, and detection of sample solution are conducted simultaneously. It is possible to perform ultrahigh-sensitivity analysis, ultratrace-amount analysis, or ultra-flexible simultaneous multi-item analysis by using a lab-on-chip. An example thereof is a chip having a protein-producing unit, a protein-purifying unit, and a protein-detecting unit that are connected to each other via microchannels.

The terms “chip”, “microchip”, or “microfluidic chip” as used herein mean that the device has microfluidic form, typically but not exclusively, containing a multitude of microchannels and chambers that may or may not be interconnected with each another.

In some embodiments, the device is biochip.

The term “biochip” is used to define a chip that is used for detection of biochemically relevant parameters from a liquid or gaseous sample. The microfluidic system of the biochip may regulate the motion of the liquids or gases on the biochip and generally may provide flow control with the aim of interaction with the analytical components, such as biosensors, for analysis of the required parameter.

The chip may include a multitude of active or passive components such as, for example and without limitation, microchannels, microvalves, micropumps, biosensors, ports, flow conduits, filters, fluidic interconnections, electrical interconnects. The terms “channel” and “microchannel” are used hereinthroughout and may comprise or be adjacent to microelectrodes, and/or related control systems.

The term “microchannel” as used herein refers to a groove or plurality of grooves created on a suitable substrate with at least one of the dimensions of the groove being in the micrometer range, e.g., 1 μm to 1000 μm.

Microchannels may be used as stand-alone units or in conjunction with other microchannels to form a network of channels with a plurality of flow paths and intersections.

The term “microfluidic”, or any grammatical derivative thereof, generally refers to the use of microchannels for transport of liquids or gases. A microfluidic system may include a multitude of microchannels forming a network and associated flow control components such as pumps, valves and filters. Microfluidic systems are ideally suited for controlling minute volumes of liquids or gases. Typically, microfluidic systems can be designed to handle fluid volumes ranging from the picoliter to the milliliter range.

In some embodiments, the term “microfluidic” refers to “smart microfluidic”.

The term “smart microfluidic” implies a microfluidic channel network wherein a certain sequence of microfluidic operations is programmed through the use of a software or structurally programmable microfluidic system.

Optionally, the device further comprises a cover layer or ceiling made of a substrate. The substrate may constitute one or more face of the device.

The term “substrate” as used herein refers to the structural component or material. A wide variety of substrate materials may be used, including, but not limited to, silicon, glass, polymers, plastics, PDMS, epoxy, acrylic, Teflon and ceramics, to name a few. The substrate material may be transparent or opaque, dimensionally rigid, semi-rigid or flexible, as per the application they are used for.

Optionally, the device comprises at least two substrate layers where one of the faces of one substrate layer contains inner parts of the device (e.g., microchannels) and one face of the second substrate layer is used to seal the inner parts of the device.

In some embodiments, the substrate may comprise a material that is capable of withstanding the thermal dissociation temperature of solid-propellant materials.

In some embodiments, the substrate (e.g., ceiling) is rigid and transparent comprising one or more materials selected from, without being limited thereto, glass, and PDMS.

Optionally, the device further comprises a spacer. In some embodiments, the spacer is disposed at a distance of e.g., 0.5 μm, 1 μm, 5 μm, 10 μm, 15 μm, 20 μm, 25 μm, 30 μm, 35 μm, 40 μm, 45 μm, 50 μm, 55 μm, 65 μm, 70 μm, 75 μm, 80 μm, 85 μm, 90 μm, 95 μm, 100 μm, 200 μm, 300 μm, 400 μm, 500 μm, 600 μm, 700 μm, 800 μm, 900 μm, 1 mm, 2 mm, 3 mm, 4 mm, or 5 mm, including any value and range therebetween.

In some embodiments, the spacer is an elastic membrane as describe hereinabove (e.g., PDMS having a defined thickness). As used herein, the term “membrane” may refer to any structure which forms a complete or partial physical barrier.

In some embodiments, the spacer is in fluid communication with the actuating liquid.

In some embodiments, the device, in any embodiments thereof, is for use for determining or detecting one or more one or more characteristics of a sample. In some embodiments, the sample is a biological sample. In some embodiments, the sample is a chemical sample.

In some embodiments, the disclosed device is configured for manipulating samples (e.g., droplets) deposited therein. The term “droplet” as used herein is meant to describe discretely formed sections of a liquid body and generally includes anything that is or can be contained within a droplet.

In some embodiment, as described hereinthroughout, the disclosed device is a microfluidic device that forms microchannels having flow characteristics.

Flow characteristics may actively vary and be formed in a compressible or distortable elastomeric material. In some embodiments, the microfluidic device is at least partially constructed of a flexible elastomeric material, such as, without limitation, an organopolysiloxane elastomer (e.g., PDMS), as described hereinthroughout. In some embodiments, as further described hereinthroughout, the device substrate may also comprise hard, e.g., substantially non-elastic material at portions, e.g., where active control is not desired.

In some embodiments, when the device of the invention is in use, liquid sample to be tested is introduced into the device at the inlet and communicated to the reaction sites.

In some embodiments, the disclosed device is configured to have a fluid communication between an inlet hole and the reaction sites. The fluid communication may be achieved via a common supply channel with branches to one or more of the reaction sites. In some embodiments, the supply channel may also be in fluid communication with a waste unit or chamber. The fluid communication may allow to excess sample to be communicated to waste and contained within the device.

The reaction sites which are formed in the device may be of any suitable shape or form. Typically, but not exclusively, the reaction site is in the form of chambers or channels or parts thereof in fluid communication with the reagent reservoir systems. Optionally, valves may be provided between the reaction sites and the reagent reservoir systems and these may operate to control flow of sample into the reaction site from the inlet.

In some embodiments, a thermal regulation is used in the device. The term “thermal regulation” as used herein refers to the ability to control the temperature of the device. Depending on the nature of the assay carried out in the disclosed device it may be advantageous or necessary to maintain a particular temperature above ambient temperature in a component of the device, or to vary the temperature of a particular component of the device during performance of an assay. The device may therefore further include heating means for supplying heat and/or controlling the temperature in a component of the device, for example, the reaction sites, mixing units, areas of the reagent reservoir system, etc. The heating means may be integrated with the other components of the device. Suitable heating means include, for example, and without being limited thereto, electronic heater.

In some embodiments, the biological assays may make use of a microcarrier. The term “microcarrier” refers to any type of particles, carriers, microscopic in size, typically, but not exclusively, with the largest dimension being from e.g., 100 nm to 300 μm, or from 1 μm to 200

In some embodiments, the term “microcarrier” refers to a microparticle functionalized, or configured to be functionalized, that is, containing, or designed to contain, one or more ligands or functional units. Ligands or functional units may be bound to the surface of the microcarriers or impregnated in its bulk.

A large spectrum of chemical and biological molecules may be attached as ligands to a microcarrier.

A microcarrier may have multiple functions and/or ligands. As used herein, the term “functional unit” is meant to refer to any species that modifies, attaches to, appends from, coats or is covalently or non-covalently bound to the surface of the microcarrier (e.g., bead) or impregnated in its bulk. The functions may refer to functions that are routinely used in high-throughput screening technology and diagnostics.

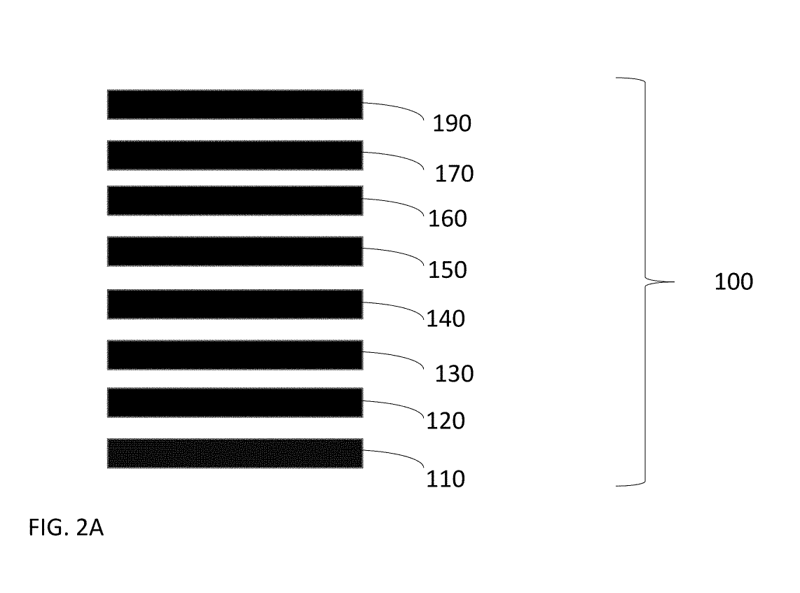

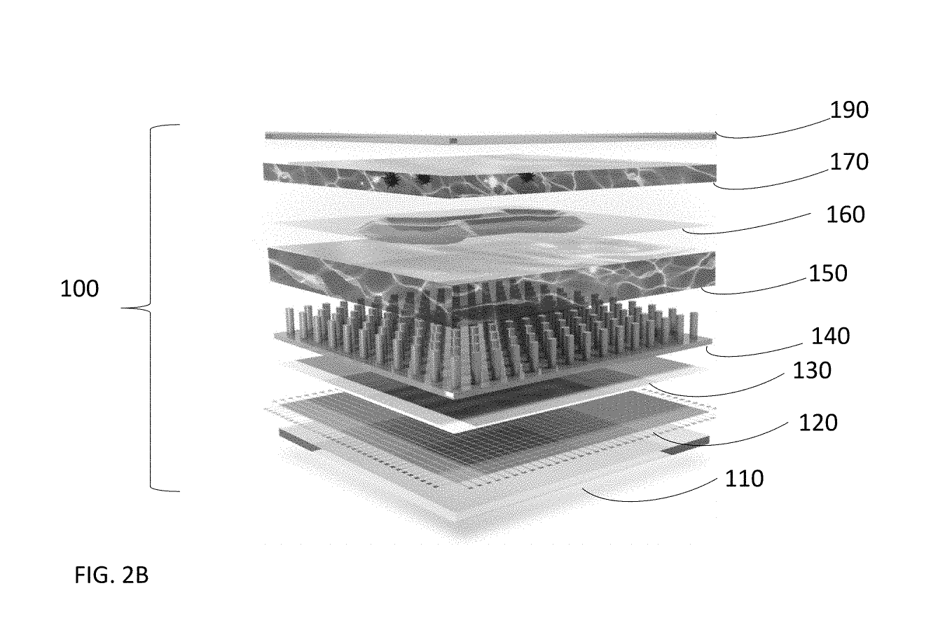

Reference is now made to FIG. 2A, which shows a perspective view of an exemplary device 100, according to some embodiments as described hereinabove.

Device 100 may have cover layer or ceiling (e.g., glass or borosilicate glass) 190. Device 100 may have bottom cover 110. Bottom cover may comprise any material described for ceiling 190. Device 100 may have electrode array 120. Device 100 may have dielectric layer 130. Device 100 may have spacer (also referred to as “membrane” or “membrane support”) 140. Device 100 may have actuation liquid 150. Device 100 may have deformable plate (membrane) 160 e.g., made of PDMS. Device 100 may include working liquid 170.

One or more components of device 100 may be disposable.

In some embodiments, the disclosed device is devoid of electrode (device having chemically patterned layer). In some embodiments, the disclosed device being devoid of electrode is configured to be operably linked to one or more electrodes.

Embodiments of ceiling 190, electrode array 120, dielectric layer 130, spacer 140, actuation liquid 150, deformable plate (membrane), and working liquid 170, are described hereinabove.

Reference is now made to FIG. 2B, which shows a 3D illustration of an exemplary configuration device 100.

In some embodiments, the liquid is suitable for performing a biological assay and/or is configured to allow loading biological samples therein.

The System

In some embodiment, there is provided a system comprising the disclosed device.

In some embodiments, the disclosed device is disposable in the disclosed system.

Optionally, the system as described herein further comprises a control unit.

Optionally, the control unit allows to induce a predetermined and variable pressure on at least a portion of the dynamically configurable layer e.g., so as to deform in response to the pressure.

Optionally, the system as described herein further comprises a photodetector.

Optionally, the system as described herein further comprises one or more probing tools. In some embodiments, the probing tool is a photomultiplier tube (PMT). In some embodiments, the probing tool is a camera. In some embodiments, the probing tool is a radioactive probe or detector. In some embodiments, the probing tool is a calorimetric detector. In some embodiments, the probing tool is a point detector. In some embodiments, the probing tool is a photodetector.

Optionally, the disclosed system further comprises a computer program product.

Optionally, the computer program product comprises a computer-readable storage medium. The computer-readable storage medium may have program code embodied therewith. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to drawings and/or diagrams of methods, apparatus (systems), and computer program products according to embodiments of the invention. It will be understood that each illustration and/or drawing, and combinations thereof, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the drawings. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the drawings.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the drawings.

In some embodiments, the program code is excusable by a hardware processor.

In some embodiments, the hardware processor is a part of the control unit.

In some embodiments, the program code is excusable by a hardware processor and/or by a control unit to one or more of the following:

inducing the pressure on a configurable layer or in the actuation chamber;

inducing a predetermined and/or variable pressure on at least a portion of the dynamically configurable layer e.g., so as to deform in response to the pressure.

obtaining predetermined configuration of the configurable layer;

capturing, isolating, and constructing networks between samples or cells of interest and/or between a sample or cells and a liquid;

pairing of multiple cells of interests;

operating one or more probing tools;

analyze multiple images of one or more labeled cells; and

identify an expression or activity of one or more proteins of the cell.

In some embodiments, there is further provided a read-out of the assay carried out in the disclosed system or device may be detected or measured using any suitable detection or measuring means known in the art. The detection means may vary depending on the nature of the read-out of the assay. For example, for assays providing a fluorescent read-out, the detection means may include a source of fluorescent light at an appropriate wavelength to excite the fluorophores in the reaction sites and means detect the emitted fluorescent light at the appropriate wavelength. The excitation light may be filtered using a bandwidth filter before the light is collimated through a lens. The same (e.g., Fresnel) lens may be used for focusing the illumination and collection of the fluorescence light. Another lens may be used to focus the fluorescent light onto the detector surface (e.g., a photomultiplier-tube). Fluorescent read-outs may also be detected using a standard fluorescent microscope fitted with a CCD camera and software. In some embodiments, disclosed system also relates to an apparatus including the device in any embodiments thereof, and a detection means as described herein.

Exemplary Samples and Assays

Unless otherwise indicated, as used herein, a “sample” refers to a fluid (e.g., gas or liquid) capable of flowing through a channel. Thus, a sample may include a fluid suspension of biologically derived particles (such as cells) as further described hereinbelow.

The sample may comprise a material in the form of a fluid suspension that can be driven through microfluidic channels can be used in the systems and methods described herein. For example, a sample can be obtained from an animal, water source, food, soil, or air. If a solid sample is obtained, such as a tissue sample or soil sample, the solid sample can be liquefied or solubilized prior to subsequent introduction into the system. If a gas sample is obtained, it may be liquefied or solubilized as well. The sample may also include a liquid or gas as the particle. For example, the sample may comprise bubbles of oil or other kinds of liquids or gases as the particles suspended in an aqueous solution. A sample can generally include suspensions, liquids, and/or fluids having at least one type of particle, cellular, droplet, or otherwise, disposed therein. Further, focusing can produce a flux of particles enriched in a first particle based on size.

The term “biological sample” as used herein refers to a sample that may originate, be obtained or isolated from any source of the animal kingdom, depending on the intended use of the method of the invention. For example, the sample may originate, be obtained or isolated from any subject of vertebrates, such as mammals, reptiles, fish, birds, and amphibians. In some embodiments, the biological sample is isolated or originating or obtained from a mammalian subject, such as a human being or a bovine subject. In other non-limiting examples, the sample is a sample originating, obtained or isolated from a ruminant, a ferret, a badger, a rodent, an elephant, a bird, a pig, a deer, a coyote, a camel, a puma, a fish, a dog, a cat, a non-human primate or a human.

In some embodiments, the biological sample is selected from a biological content selected from a single cell, a population of cells, urine sample, sputum sample, cerebrospinal fluid, cell extract, tissue sample, blood sample, viruses, virus particles, protein, nucleotide(s) (e.g., DNA, RNA) or metabolites.

In some embodiments, the protein is selected from a growth factor, cytokine, chemokine, neurotransmitter, antibody or an enzyme.

In some embodiments, the term “isolated” refers to isolated from the natural environment. In some embodiments, the term relates to blood or tissue sample isolated from a subject to be diagnosed.

Exemplary biological samples can include, but are not limited to, cells, alive or fixed, such as adult red blood cells, fetal red blood cells, trophoblasts, fetal fibroblasts, white blood cells, epithelial cells, tumor cells, cancer cells, hematopoeitic stem cells, bacterial cells, mammalian cells, plant cells, neutrophils, T lymphocytes, B lymphocytes, monocytes, eosinophils, natural killer cells, basophils, dendritic cells, circulating endothelial cells, antigen specific T-cells, and fungal cells.

In some embodiments, the biological sample is a blood sample, a tissue sample, a secretion sample, semen, ovum, hairs, nails, tears, urine, biopsy or faeces. A common sample type is a blood sample. The blood sample may include any fraction of blood, such as blood plasma or blood serum, sputum, urine, cell smear.

In some embodiments, the biological sample may also be a tissue sample, such as a sample of a tissue selected from the group consisting of skin, epidermis, dermis, hypodermis, breast, fat, thymus, gut, small intestine, large intestine, stomach, muscle, pancreas, heart muscle, skeletal muscle, smooth muscle, liver, lung, brain, cornea and tumors, ovarian tissue, uterine tissue, colon tissue, prostate tissue, lung tissue, renal tissue, thymus tissue, testis tissue, hematopoietic tissue, bone marrow, urogenital tissue, expiration air, stem cells, including cancer stem cells, biopsies, and cerebrospinal fluid. In some embodiments, the sample is blood plasma, blood serum, sputum, urine, cell smear, faeces, cerebrospinal fluid, or a biopsy.

In some embodiments, the biological sample is obtained from any source of human or animal consumption, such as food or feed; i.e. the sample is a food or feed sample. In some embodiments, the sample is water, such as, without limitation, drinking water and domestic water.

The terms “biological assay” or “bioassay” as used herein interchangeably may refer to any assay involving a biological sample. Bioassays are performed in order to determine the presence or concentration or any other desired attributes of a biological molecule or a cell or cell population or an organism. Non-limiting example of bioassays that can be performed using the disclosed system or method are: enzymatic assay, a binding assay, immunoassay, nucleic acid hybridization, PCR, electrophoresis, liquid chromatography, cell activation, cell migration, cell separation, cell quantification, proteomic analysis, genomic analysis, DNA sequencing, microorganism detection, viral detection, DNA/RNA microarray, antibody array.

The sample may be diluted or concentrated prior to application to the device or it may be subject to pre- treatment steps to alter the composition, form or some other property of the sample. Pre-treatment steps may include, for example, cell lysis.

As used herein the term “immunoassay” refers to a biochemical test that measures the level of a substance in a biological liquid, such as serum or urine, using the reaction of an antibody and its antigen. The assay takes advantage of the specific binding of an antibody to its antigen. Monoclonal antibodies are often used as they only usually bind to one site of a particular molecule, and therefore provide a more specific and accurate test, which is less easily confused by the presence of other molecules. The antibodies picked must have a high affinity to the antigen (if there is antigen in the sample, a very high proportion of it must bind to the antibody so that even when only a few antigens are present, they can be detected). In an immunoassay, either the presence of antigen or the patient's own antibodies (which in some cases are indicative of a disease) may be measured. For instance, when detecting infection the presence an antibody against the pathogen is measured. For measuring hormones such as insulin, the insulin acts as the antigen. Typically, for numerical results, the response of the fluid being measured is compared to standards of a known concentration. The detection of the quantity of antibody or antigen present can be achieved by either the antigen or antibody. An antibody may be primary or secondary.

The term “primary antibody” as used herein, refers to a component of the immunoassay. Typically, the “primary” or “capture” antibody is positioned at a pre-determined location on a substrate and subsequently exposed to an array of antigens. Only the antigens associated with the capture antibody will combine irreversibly with the antibody. The terms “primary antibody” and “capture antibody” are used interchangeably in this description.

In some embodiments, the term “secondary antibody” refers to the signaling component of the immunoassay. The secondary antibody may be labeled with a fluorescent dye (in the case of fluorescent detection) or with an enzyme (for electrochemical or ELISA or chemiluminescent detection). The secondary antibody will selectively bind with the antigens (which are typically already bound to the primary antibody and thus fixed to the substrate), and is then subsequently interrogated using an appropriate technique.

In some embodiments, detection of the immuno complex is performed using fluorescence activated cell sorting (FACS), enzyme linked immunosorbent assay (ELISA), Western blot and radio-immunoassay (MA) analyses, immunoprecipitation (IP) with optionally the use of magnetic beads or by a molecular weight-based approach.

“Cell culture” is an essential tool in biological science, clinical science, and biotechnology.

Embodiments of microfluidic devices may be suitable for the culture of a living organism in a fluid. A microfluidic device may control the flow and composition of fluids provided to the living organism. The microfluidic device may provide laminar, pseudo-multiple laminar or non-laminar flows. The microfluidic device may perform physical operations on the living organism. The microfluidic device may be used, for example, for general cell culture including cell washing and detachment, cell seeding and culture. The microfluidic device may be used as a microreactor, a tissue culture device, a cell culture device, a cell sorting device, a cell crushing device, a micro flow cytometer, a motile sperm sorter, a micro carburetor, a micro spectrophotometer, or a microscale tissue engineering device. The microfluidic device may include sensors to determine states or flow characteristics of elements of the microfluidic device or the passage of particles in a channel. The sensors may be, for example, optical, electrical, or electromechanical sensors. Microfluidic devices allow a user to work with nano- to microliter volumes of fluids and are useful for reducing reagent consumption, creating physiologic cell culture environments that better match the fluid-to-cell-volume ratios in vivo, and performing experiments that take advantage of low Reynolds number phenomenon such as subcellular treatment of cells with multiple laminar streams.

As described hereinthroughout, microfluidic systems, such as the disclosed device, may be partially made of PDMS because of its favorable mechanical properties, optical transparency, and bio-compatibility.

Microfluidic cell culture devices have been developed for diverse cell types such as Eukaryotic cells, lung cells, embryonic stem cells, and mammalian embryos.

Most microfluidic cell culture devices separate cell loading zones from designated cell culture zones. This separation requires additional external forces and elaborate works for the cell in the loading zone to be transported to the designated culture zone. Also, the transport processes can put stress on sensitive cells such as mammalian embryo or embryonic stem cells. In addition, once the cells reach the designated culture zone, additional design and fabrications are required for cell confinement to apply diverse culture conditions with flows.

As noted hereinabove, the device of the present invention may be used for the study and characterization of cellular networks or cell-cell interactions. Cell-cell interactions play a key role in the development and activities of multicellular organisms. Stable cell-cell interactions maintain the integrity and functions of cells in tissues. More transient cell-cell interactions through multivalent ligand-receptor interaction on the cell surface underlie many aspects of immune responses, including target recognition, immune cell activation and target elimination. For example, cells of the immune systems detect foreign antigens presented on the surface of infected cells, or identify and eliminate cancer cells that exhibit aberrant cell surface proteins.

In some embodiments, the cell-cell interaction may be detected and verified by any suitable methods known in the art. For example, cell-cell interaction can result in cell aggregation. Aggregated cells may be detected based on size differential as revealed by density gradient or flow cytometry. Different types of cells can be first labeled with specific fluorescent dyes and the cell aggregates can be detected by flow cytometry. Cell-cell interaction may also be directly examined and verified by fluorescence microscopy. All the embodiments of this aspect may be applied in conjunction with any embodiments of the invention described herein.

In some embodiments, the device is configured to form reaction chambers and microchannels and may be reshaped dynamically so as to generate, e.g., complex experimental design in which cells are manipulated to be mixed and separated continuously where different liquids may be introduced and removed.

In some embodiments, the device may be used for cell crushing. Cells may be crushed by e.g., transporting them in channels through active portions and actuating channel closure to crush the cells flowing through the channels.

As described hereinabove, the disclosed device may be used for the characterization of biomolecules. Some non-limiting examples of assays for the characterization of biomolecules are set forth.

In some embodiments, the biological assay, such as, without limitation, immunoassays and gene expression analysis, is carried out using microarray, such as nucleotide (DNA) microarray, protein microarray or antibody microarray, for example.

A microarray is a collection of microscopic spots such as DNA, proteins or antibodies, attached to a substrate surface, (such as a glass, plastic or silicon), and which thereby form a “microscopic” array. Such microarrays may be used to measure the expression levels of large numbers of genes or proteins simultaneously. Typically, but not exclusively, biomolecules, such as, without limitation, DNA, proteins or antibodies, on a microarray chip are detected through optical readout of fluorescent labels attached to a target molecule that is specifically attached or hybridized to a probe molecule. The labels used may comprise e.g., an enzyme, radioisotopes, or a fluorophore.

According to some embodiments, the herein disclosed devices may be used so as to conduct high throughput separation and analysis.

The separation may be based on accurate flow controls through the microfluidic channels. By designing patterned fluidic channels, or channels with specific dimensions in the micro or sub-micro scales, often on a small chip, it is possible to carry out multiple assays simultaneously. As further detailed hereinbelow, the cells and biomolecules in microfluidic assays may be detected by optical readout of fluorescent labels attached to a target cell or molecule that is specifically attached or hybridized to a probe molecule.

In some embodiments, the disclosed device and methods are used for integrated nucleic acid (DNA, RNA, cDNA, etc.) extraction and fractionation of different molecular weight nucleic acid molecules, from biological and clinical samples for downstream applications such as, but not limited to, polymerase chain reaction (PCR), Helicase-dependent amplification (HDA), recombinase polymerase amplification (RPA), Hybridization (such as southern blotting, microarrays, expression arrays, etc.), DNA sequencing (including integrated extraction and size selection for paired-end sequencing) and other related applications.

Methodologies for analyzing the sequence and biology of DNA or RNA presently used in the art merely collect all DNA present in a biological or clinical sample. Separation of DNA fragments based on molecular weight provides a method for enriching samples for specific DNA of interest. For example, a molecular diagnostic test for a blood born bacterial infection would benefit from enriching the sample for molecular weight DNA in the size range of the bacterial genomic DNA (gDNA) and discarding smaller fragments of DNA and larger fragments of human DNA.

A lab-on-a-chip device, as presented hereinthroughout, may be used e.g., for both extracting DNA and selecting for the DNA molecular weight.

In some embodiments, the disclosed device may be used as a biosensor. As defined herein and in the art, biosensors are analytical devices that combine a biological material (tissues, microorganisms, enzymes, antibodies, nucleic acids etc.) or a biologically-derived material with a physicochemical transducer or transducing microsystem. This transducer may be e.g., optical, electrochemical, thermometric, piezoelectric, magnetic or radioactive. Biosensors may yield a digital electronic signal which is proportional to the concentration of a specific analyte or group of analytes. While the signal may in principle be continuous, the disclosed devices may be configured to yield single measurements to meet specific application requirements. Biosensors may be used in a wide variety of analytical problems including those found in medicine, the environment, food processing industries, security and defense.

In some embodiments, the biological assay includes introduction of a biologically active agent to a sample. Non-limiting examples of biologically active agents are selected from drugs, such as, anticancer drug or combination of drugs, retinoic acid, monoclonal antibody, siRNA, RNA, microRNA, DNA, a plasmid a bisphosphonate, antibacterial and antifungecide reagent.

In some embodiments of the disclosed device, the surface of the channels and reaction chambers may be treated so as to prevent or to reduce adsorption on a surface thereof a material of sample constituents or a reaction product. Such surface treatment may comprise methods including but not limited to: flowing a sacrificial substance through the channel, thereby reducing loss of material, treating the surface with biological material such as bovine serum, polymerase enzymes or other such materials, or chemically treating the surface to prevent loss. Treatments may include, but are not limited to, the placement of materials that may create a hydrophilic or hydrophobic surface to allow a smoother flow. In some embodiments, fluorocarbons and similar materials (Teflon, as an example would act as a hydrophobic barrier, or polyacrylates) may be deposited on to the surface of the channels and/or reaction chambers. Other methodologies such as UV coatings and polymer brushes that are chemically grown off the surface may also be contemplated.

In some embodiments, any surface treatment known in the art may be applied to the membrane or to the surface of the microfluidic channels or chambers of the disclosed device e.g., to prevent enzymes from denaturing thereon. In some embodiments, this treatment may actually enhance the performance of the enzyme or allow further stability of the enzyme.

In some embodiments, the enzyme may be attached to a membrane of the device using chemical or biological linker. Such linkers may include but are not limited to di-sulfide linkers, bis-amine linkers, silane chemistries, peptide recognition moieties, histidine tagging linkers, ion recognition moieties as well as biological species that may show an affinity to the surface and/or the enzyme itself. In some embodiments, the enzymes (e.g., polymerase) may bind to surface species or be coupled with enzymes with such properties.

In some embodiments, the enzymes may be placed in certain regions of the disclosed device e.g., to provide optimum conditions for a reaction to take place. In some embodiments, this placement may be carried out e.g., by enhancing the enzyme affinity to one or more desired areas within the device. In some embodiments, there is provided a kit comprising the disclosed device, in any embodiment thereof. In some embodiments, the kit may be used for certain medical uses including, without being limited thereto, diagnostics.

The term “diagnosis” and any grammatical derivative thereof, as use herein, refers to a method of determining a disease or disorder in a subject. In some embodiments, the term “diagnosis” refers to determining presence or absence of pathology, classifying pathology or a symptom or determining a severity of the pathology.

For example, the method may comprise identifying a microorganism or a biomarker in a sample from the subject wherein the presence of the microorganism in the sample is e.g., indicative of the disease or disorder.

The terms “diagnosis” may also refer to “prognosis” which may include monitoring the diagnosis and/or prognosis over time, and/or statistical modeling based thereupon. That is, in some embodiments, the diagnosis may include: a. prediction (e.g., determining if a patient will likely develop a hyperproliferative disease) b. prognosis (predicting whether a patient will likely have a better or worse outcome at a pre-selected time in the future) c. therapy selection.

In some embodiments, the term “prognosis” as used herein refers to forecasting an outcome of pathology and/or prospects of recovery including the efficacy of medication or treatment. In some embodiments, the term “prognosis” further refers to the determination of tumor progress.

The terms “marker”, or “biomarker”, refer to a biomolecule that is generated in response to a specific physiological condition. For example, muscular stress injuries cause the release of a biomarker called CRP whereas cardiovascular injuries cause the liberation of Cardiac Troponins. Biomarkers may or may not be uniquely associated with a particular physiological condition.

In some embodiments, the disclosed device is further used to assess the change in status of the expression of a biomarker. The term “status” in this context is used according to its art accepted meaning and refers to the condition or state of a gene and/or its products including mRNA and protein. Typically, skilled artisans use a number of parameters to evaluate the condition or state of a gene and its products. These include, in some embodiments, but are not limited to, the location of expressed gene products (including the location of the marker expressing cells) as well as the level, and biological activity of expressed gene products (such as mRNA and polypeptides). In some embodiments, an alteration in the status of biomarker exhibits a change in the location of the mRNA or protein and/or the cell marker and/or an increase in the cell marker mRNA and/or protein expression, or any combination thereof.

As a non-limiting example, the method and device described herein may be used for screening or diagnosing a disease, e.g., cancer. In some embodiments, a cancer cell marker probe is a labeled antibody which specifically recognizes a cancer cell marker. In some embodiments, a cancer cell marker probe is a primary antibody which specifically recognizes a cancer cell marker and a secondary antibody comprising a label. In some embodiments, a cancer cell marker probe is a labeled nucleic acid molecule which specifically recognizes a cancer cell marker. In some embodiments, a cancer cell marker probe is a labeled protein which specifically recognizes a cancer cell marker. In another embodiment, a cancer cell marker probe is a labeled small molecule which specifically recognizes a cancer cell marker.

In some embodiments, determining a level of a protein is performed by quantifying the amount of the protein in a sample by an indirect method such as, but not limited to, ELISA. In some embodiments, determining a level of a protein is performed by immunohistochemical analysis on a target tissue and quantifying the intensity and/or number of cells labeled. In some embodiments, any method known in the art for detecting and directly/indirectly quantifying a protein within cells or a tissue, may be applied. In some embodiments, a predetermined reference value is obtained by measuring the level of a protein (or proteins) in a parallel healthy tissue or cells. In some embodiments, a predetermined reference value is obtained by measuring the level of a protein (or proteins) in a parallel non-malignant tissue or cells. In some embodiments, a predetermined reference value is obtained by measuring the level of a protein (or proteins) in a parallel inflamed tissue.

As used herein, the term “level” refers to the degree of gene expression and/or gene product expression or activity in the biological sample. Accordingly, the level of a protein of the invention serving as a marker is determined, in some embodiments, at the amino acid level using protein detection methods.

In some embodiments, the device or kit disclosed herein is used for drug discovery.

By “drug discovery” it is meant to refer to measuring drug activity, and/or for evaluating the effect of a candidate drug on a cell, cell type or microorganism.

Further embodiments are described below under Exemplary Analysis Methods.

Exemplary Analysis Methods

In some embodiments, there is provided a method of sample analysis, the method comprising the steps of:
(a) depositing a sample of interest to be analyzed on a surface, the surface being a configurable or deformable membrane described hereinthroughout;
(b) establishing a kinetic process on the surface, thereby inducing pressure distributions on the surface and deformation thereof, the deformation comprising one or more spatial gradient regions.

Herein, “sample analysis” may be a single cell analysis and/or chemical analysis on small volume such as micro-sized volume. In some embodiments, the analysis is chemical analysis. The term chemical analysis can refer to, for example, the qualitative and/or quantitative detection and/or separation of molecules of interest. In some embodiments, the device and method disclosed herein enables processing large volumes of samples (e.g., hundreds of μL) in short period of time (relative to the time required using other alternatives such as low current).

As noted hereinabove, in some embodiments, the deformable plate is in fluid communication with an actuation chamber. In some embodiments, the actuation chamber comprises an actuation surface and an actuation liquid. In some embodiments, the actuation layer, actuation liquid, and deformable plate are substantially parallel to each other. In some embodiments, the actuation chamber is configured to provide a predetermined pressure in one or more portions of the deformable plate.

In some embodiments, the kinetic process is an electrokinetic process. In some embodiments, the electrokinetic process comprises a step of applying an electric field so as to establish pressure gradients on the membrane's surface.

In some embodiments, the term “kinetic process” refers to actuation mechanism, which may allow, inter alia, changing topography of a subsurface. The term “topography” is used here to include both static and dynamic topography.

In some embodiments, the kinetic process may be regulated automatically.

In some embodiments, the kinetic process is electroosmotic and/or pressure driven.

By “electroosmotic driven” it is meant to refer to the general flow of a liquid (e.g., electrolyte) when subjected to an electric field.

In some embodiments, the kinetic process is driven by dielectrophoresis (DEP).

In some embodiments, the kinetic process is driven by electroosmosis e.g., induced charge electroosmosis (ICEO)

In some embodiments, the kinetic process is driven by electrostatic force. In some embodiments, the kinetic process is driven by electric field between two or more electrodes. The term “electric field” may refer to a direct current (DC) electric field or, in some embodiments, to an alternating current (AC) electrical field. In some embodiments, the electric force is applied directly to at least one a portion of the configurable plate, for example, via DEP or electrostatic mechanism. In some embodiments, the electric force is applied indirectly to at least on surface of the configurable plate through actuation of the liquid, for example, via ICEO or electroosmotic flow.

In some embodiments, the electrokinetic process triggers or results in performing at least one pre-defined action. In another embodiment, the action performed in response to an electric current/voltage change is pressure modulation of the deformable plate's surface. Non-limiting examples of pre-defined actions, which may be performed in response to an electric current/voltage change as described herein include: substantially modulating the electric field for a pre-determined period of time; applying a counter-flow for a pre-determined period of time, and modulating the temperature in a pre-determined zone in the flow channel.

In some embodiments, the action performed in response to an electric current/voltage change is substantially modulating the electric field for a pre-determined period of time. In some embodiments, the modulating is reducing the electric field. In some embodiments, the modulating is switching the electric field off. In some embodiments, the modulating is enhancing the electric field.

In another embodiment, the action performed in response to an electric current/voltage change is applying a counter-flow (e.g., a flow countering the electric field) for a pre-determined period of time.

In some embodiments, the method further comprises a step of labeling the samples e.g., using a labeling agent. As used herein, the phrase “labeling agent” or “labeling compound” describes a detectable moiety or a probe. Exemplary labeling agents which are suitable for use in the context of these embodiments include, but are not limited to, a fluorescent agent, a radioactive agent, a near IR dye (e.g., indocyamine green), a rhodamine dye, a fluorescein dye, a magnetic agent or nanoparticle, a chromophore, a photochromic compound, a bioluminescent agent, a chemiluminescent agent, a phosphorescent agent and a heavy metal cluster.

In some embodiments, the label is a dye. In some embodiments, the label is a fluorescent dye. In other embodiments, the label is a radioactive agent. In some embodiments, the label is a metal such as but not limited to gold or silver.

The phrase “radioactive agent” describes a substance (i.e. radionuclide or radioisotope) which loses energy (decaysy emitting ionizing particles and radiation. When the substance decays, its presence can be determined by detecting the radiation emitted by it. For these purposes, a particularly useful type of radioactive decay is positron emission. Exemplary radioactive agents include ⁹⁹mTc ¹⁸F, ¹³¹I and ¹²³I.

As used herein, the term “chromophore” describes a chemical moiety that, when attached to another molecule, renders the latter colored and thus visible when various spectrophotometric measurements are applied.

The term “bioluminescent agent” describes a substance which emits light by a biochemical process.

The term “chemiluminescent agent” describes a substance which emits light as the result of a chemical reaction.

The phrase “fluorescent agent” refers to a compound that emits light at a specific wavelength during exposure to radiation from an external source.

The term “fluorescent detection” refers to a process wherein, excitation is supplied in the form of optical energy to a particular molecule which will then absorb the energy and subsequently release the energy at another wavelength. The fluorescent detection technique requires the use of an excitation source, excitation filter, detection filter and detector.

The term “chemiluminescence” refers to a process wherein certain molecules when catalyzed in the presence of an enzyme, undergo a specific biochemical reaction and emit light at a particular wavelength as a result of this reaction. Chemiluminescent detection techniques only require a detector without the need for an excitation source or filters.

The phrase “phosphorescent agent” refers to a compound emitting light without appreciable heat or external excitation.

A heavy metal cluster can be for example a cluster of gold atoms used, for example, for labeling for e.g., electron microscopy examination.

Detection of nucleic acid substrate both processed and non-processed substrates may be obtained by use of different tailored primers and probes, e.g., oligonucleotide primers and/or oligonucleotide primers and probes of any suitable lengths may be used, for example, oligonucleotides of 5-300 nucleotides, such as 10-200, 20-100, or 20-50 consecutive nucleotides.

Cell detection may be achieved, for example, by flow cytometry techniques using transparent microfluidic devices and suitable detectors. Embedding optical fibers at various angles to the channel can facilitate detection and activation of the appropriate activators. Similar detection techniques, coupled with the use of valves to vary the delivery from a channel to respective different collection sites or reservoirs may be used to sort embryos and microorganisms, including bacteria, fungi, algae, yeast, viruses, sperm cells, etc.

General

As used herein the term “about” refers to ±10%.

The terms “comprises”, “comprising”, “includes”, “including”, “having” and their conjugates mean “including but not limited to”. The term “consisting of” means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together,

B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

### EXAMPLES

Reference is now made to the following examples which, together with the above descriptions disclosed herewith, illustrate the invention in a non-limiting fashion.

### A) Exemplary Device

In exemplary device, the electrodes are covered by a layer of dielectric material to prevent faradaic reactions with the liquid. A thin PDMS membrane will be placed at a distance of 10-50 μm from the electrodes, and, if necessary, is supported by an array of poles fabricated using thiol-ene chemistry to prevent sticking to the membrane. The density of the poles is low compared to the density of the electrodes, to minimize any effect on the EOF-driven fluid flow. Surface potential in the electrodes may induce pressures in the actuation liquid, resulting in deformation of the membrane. The working liquid (in which the cell resides) is located on top of the membrane, forming another gap of 10 to 50 μm to the ceiling. The ceiling is be made of a rigid layer of PDMS, allowing clear optical access.

### B) Configuration and Actuation System

In an exemplary setting electrokinetically driven surface deformations are defined and used to create a library of fundamental structural elements that are implemented using the devices and methods of the present invention. Such elements include: confinements, channels, filters, traps, peristaltic pumps, cell transporters, and more. These elements are superposed to obtain complex configurations on-chip, allowing for the investigation of single cell systems by capturing, isolating and constructing networks between cells of interest.

EOF (electroosmotic flow) is an electrokinetic phenomenon associated with transport of a liquid in the presence of a diffusive, electrically charged double layer. Without being bound by a particular theory or mechanism, while EOF near electrically uniform surfaces does not impose pressure on the confining walls, the case of non-uniformly charged surfaces inevitably leads to inherent pressure gradients.

Exemplary analytical expressions relating the spatial distribution of the surface potential (x, y) in a shallow flow chamber to the resulting depth-averaged velocity and pressure distribution are given by the following equations, (1) and (2), respectively:

$$\begin{matrix}- \frac{1}{12} {∇}_{\vert \vert}^{2} p + {E}_{\vert \vert} \cdot {∇}_{\vert \vert} 〈 ζ 〉 = 0 , & 1 \\ \frac{1}{12} {∇}_{\vert \vert}^{2} ψ + {E}_{\vert \vert} \times {∇}_{\vert \vert} 〈 ζ 〉 = 0. & 2\end{matrix}$$

where p is the pressure, E is the in-plane electric field, and ψ is the streamline function of the in-plane velocity. As described in the introduction, we showed the existence of a fundamental dipole solution which can be superposed to obtain desired flow fields and pressure gradients.

Both equations are Poisson-type, with the gradients in zeta potential serving as source terms. Equation (Eq.) 1 above shows that the source term that determines the pressure depends on the gradient of the zeta potential in the direction of the electric field. In the device of the present invention one of the planes confining the flow is flexible, thus translating the resulting pressure gradients into deformations.

The analysis considers the case of small membrane deformation, where a linear elastic model holds, and provides an expression relating the desired deformation, h, to the required induced surface potential distribution (equation 3):

$$\frac{\partial ζ}{\partial x} = \frac{ϵ {Yh}^{3} {w}^{3}}{72 E ( 1 - {σ}^{2} )} ( \frac{{\partial }^{2}}{\partial {x}^{2}} + \frac{{\partial }^{2}}{\partial {y}^{2}} ) h \qquad 3$$

Here, ∈ is the electric field, assumed oriented along the x-axis, while Y, h, and w are the membrane's Young modulus, Poisson ratio, and thickness, respectively. While simplified, Eq. (3) already represents the solution to an inverse problem in which the desired deformation provides the necessary surface potential distribution.

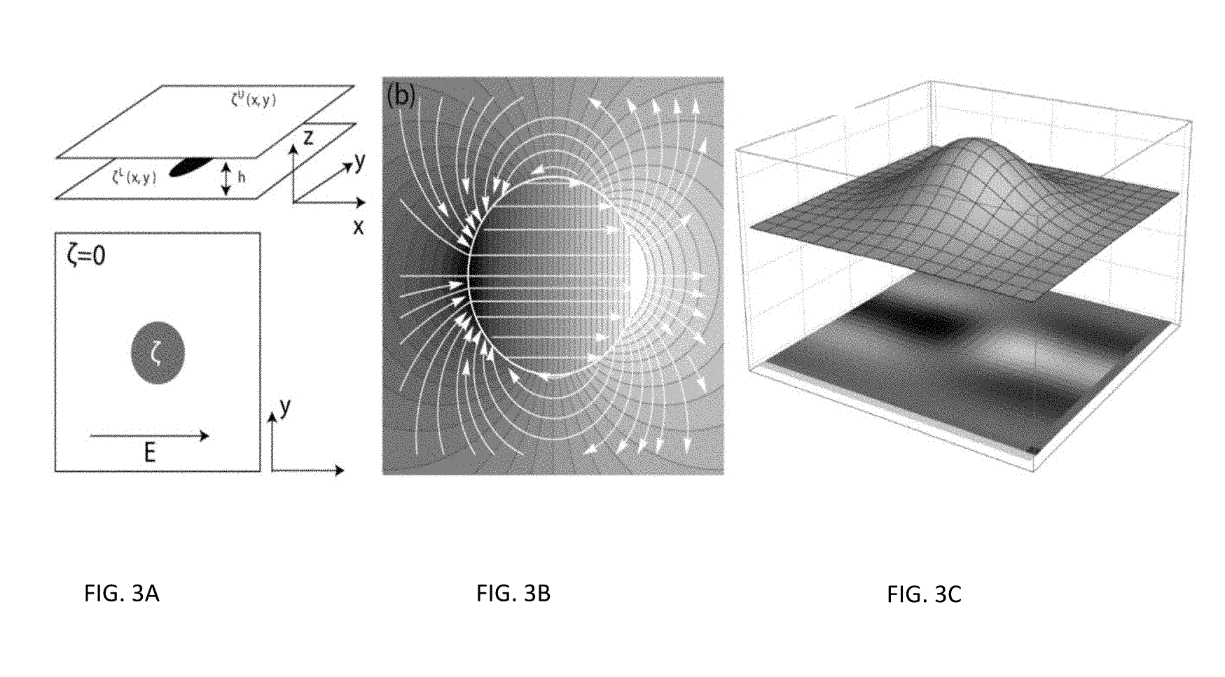

Reference is now made to FIGS. 3A-C which illustrate, without wishing to be bound by any particular theory, the simplest and most fundamental case of non-uniform surface potential: a flow chamber consisting of two large parallel plates separated by narrow gap is considered. The two plate surfaces are mostly electrically neutral, except for a disk-shaped region which is functionalized to have a finite surface charge (and thus a surface potential ζ). A uniform electric field is applied to the liquid enclosed between the plates. The resulting discontinuity in the boundary conditions for the velocity gives rise to very high internal pressure gradients in the chamber, which ensure mass conservation and continuity of the flow. The resulting flow field is that of a perfect dipole, which significantly simplifies subsequent analysis. Such dipoles can be superposed to obtain complex flow fields or pressure distributions in the flow chamber.

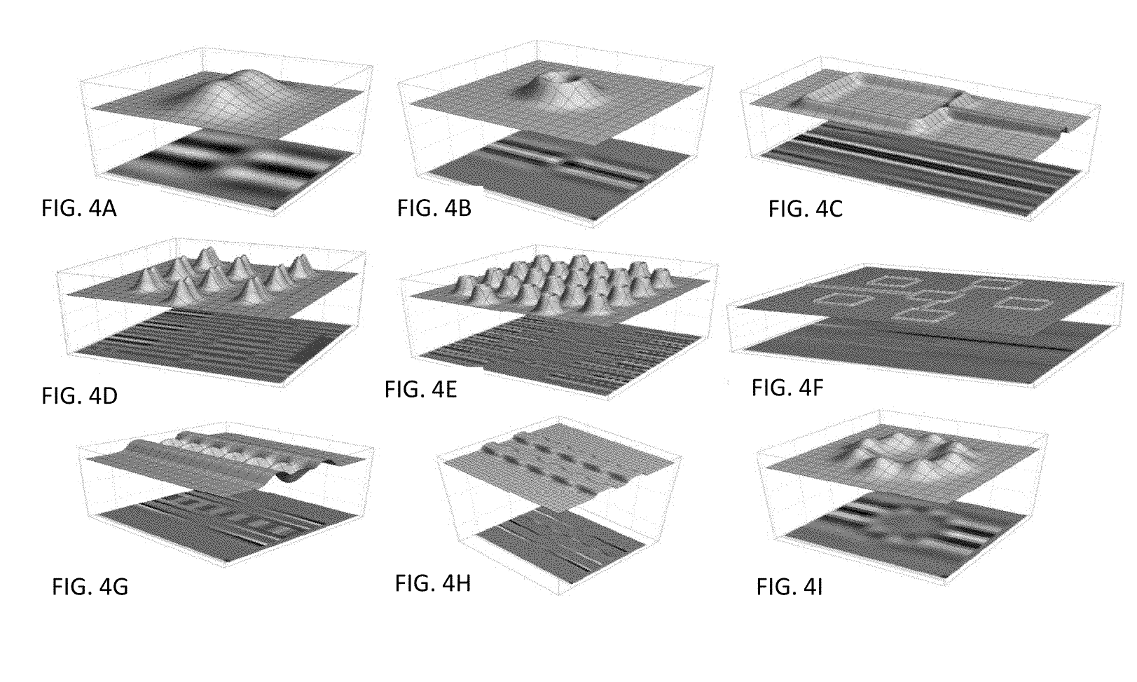

FIGS. 4A-I present results in which this equation is used to obtain the solutions for several fundamental microfluidic elements in a structure library. Preliminary data showing an initial library of elements that could be implemented on the chip. All solutions are obtained from analytical superposition of elementary Gaussian elements based on the solution of Eq (3). Two overlapping Gaussians can be used to create a narrow gap (narrower than the electrode resolution) for trapping flowing cells (FIG. 4A). A closed chamber for holding cells in a confined region without interaction with the environment (FIG. 4B). A large chamber allowing cell culturing, together with a narrow microchannel for potential connection with other chambers (FIG. 4C). All elements could be multiplexed to create arrays of, for example, cell traps and confinements (FIG. 4D-E). Cells residing in separate chambers can be dynamically connected to allow or block chemical interaction between the cells (FIG. 4F). Two examples of traveling waves (vertical and planar) that can be produced to implement fluid transport via peristaltic pumping (FIG. 4G-H). A diffusive cell trap used to hold a cell in place, while allowing diffusive communication with its neighbors (FIG. 4I).

Configuration can be modified dynamically to obtain elements such as pumps and valves. In exemplary configuration, the chip is constructed as a “sandwich” structure composed of multiple layers, as detailed FIGS. 1A-B, and 2A-B. Each layer is created using standard microfabrication processes known in the art. The chip is composed of a bottom actuation chamber, where actuation pressures are formed, and a top working chamber, where cells are manipulated. The two chambers are separated by, e.g., 5-25 μm PDMS layer serving as the flexible actuation membrane. Given the Young modulus of PDMS (˜500 kPa), this thickness provides the necessary deformation capabilities, while still allowing for standard handling and fabrication of the membrane. The actuation chamber is driven by an array of electrodes created by either Pt—Ti or ITO deposition which enables to image the chip from below. The array is insulated by either a layer of parylene created by chemical vapor deposition (CVD) or by spin coating a thin layer of PDMS, similar to the fabrication of digital microfluidic arrays. On top of it, a 10-50 μm thick PDMS frame serves as a spacer between the electrode array and the actuation membrane. A similar frame is placed on the top side of the membrane, defining the outer perimeter of the working area. Finally, the entire structure is covered by a thick layer of PDMS, allowing optical access to the cells from the top. The top PDMS cover has an array of twelve 1 mm diameter through-holes which serve as inlets and outlets to the working chamber of the chip.

In an exemplary setting, the system is built with a single electrode actuator, and the flow field is measured by seeding the flow with 100 nm fluorescent particles, and imaging from above. The data is analyzed using conventional particle image velocimetry (pPIV) techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A device comprising:
a chamber comprising actuation medium;
an electrode layer comprising at least one electrode; and
a dynamically configurable layer,
wherein the at least one electrode is configured to induce a predetermined and variable pressure on at least a portion of said dynamically configurable layer, and wherein the configurable layer is configured to deform responsively to the pressure.

2. The device of claim 1 in the form of a multiple stacked layers, the device comprising:
(i) an actuation layer comprising the electrode layer, optionally wherein: the electrode layer is deposited on or incorporated in at least a portion of said dynamically configurable layer; optionally said at least one electrode is a light pattern electrode, and optionally wherein said actuation layer comprises chemically patterned layer;
(ii) an actuation medium, optionally wherein said actuation medium comprises a liquid selected from Newtonian liquid and non-Newtonian liquid; and optionally wherein said non-Newtonian liquid comprises a material selected from the group consisting of Poly(acrylic acid) (PAA), carboxymethyl cellulose (CMC), or a combination thereof; and
(iii) a dynamically configurable layer.

3. (canceled)

4. The device claim 1, wherein at least a portion of the electrode has one or more layers of dielectric material deposited thereon.

5. The device of claim 2, wherein said actuation medium is in fluid communication with said dynamically configurable layer, wherein said actuation medium is in fluid communication with said actuation layer and said dynamically configurable layer.

6. (canceled)

7. The device of claim 1, wherein said at least one electrode is selected from the group consisting of platinum, gold, silver, aluminum, titanium, antimony, bismuth, carbon, iridium, zinc oxide, and indium tin oxide (ITO), or any combination thereof.

8.-12. (canceled)

13. The device of claim 1, wherein said dynamically configurable layer is an elastic membrane characterized by E*h³ having a value between 10⁻¹³ to 10⁻⁹ N*m, wherein “E” is Young's modulus of said membrane, and “h” is a thickness of said membrane.

14. The device of claim 2, wherein:
(i) said dynamically configurable layer has a thickness of less than 500 μm, and optionally is an elastic membrane comprising a polymer selected from the group consisting of: poly(dimethylsiloxane) (PDMS), low density Poly(ethylene) (LDPE), Poly(vinyl chloride) (PVC), and Poly(imide), or a combination thereof;
(ii) optionally, the decice further comprises a ceiling comprising one or more materials selected from glass, polymer, PDMS, silicon, epoxy, acrylic, and teflon;
(iii) optionally, the device further comprises a spacer being disposed at a distance that ranges from 1 to 100 μm from said actuation layer, or optionally from 1 to 50 μm from said actuation layer; and optionally wherein:
(iv) the spacer is in fluid communication with said actuating medium.

15. (canceled)

16. The device of claim 1, further comprising a liquid atop said dynamically configurable layer, said liquid is configured to allow loading biological samples therein.

17.-19. (canceled)

20. A system comprising the device of claim 1, optionally said system further comprising one or more probing tools selected from: a microscope, a photodetector, a photomultiplier tube (PMT), a conductivity detector, a point detector a radioactive detector, a camera, and any combination thereof.

21. (canceled)

22. The system of claim 20, further comprising a control unit configured to induce a predetermined and variable pressure on at least a portion of said dynamically configurable layer so as to deform in response to the pressure.

23. A method comprising the steps of:
(a) providing the device of claim 1,
(b) establishing a kinetic process on at least a portion of the dynamically configurable layer, so as to provide pressure distributions on a surface thereof, the deformation comprising one or more spatial gradient regions.

24. A method of sample analysis, the method comprising the steps of:
(a) providing a device comprising:
an actuation layer;
an actuation medium, and
a dynamically configurable layer,
(b) placing a sample to be analyzed on a surface of said dynamically configurable layer; and
(c) establishing a kinetic process on said actuation medium so as to deform said surface, wherein the deformation of said surface comprises one or more spatial gradient regions.

25. The method of claim 24, wherein step (c) is induced by at least one electrode layer having one or more layers of dielectric material deposited thereon, and optionally wherein said sample is selected from a biological content selected from: a single cell, a population of cells, cell extract, tissue sample, blood sample, urine sample, sputum sample, cerebrospinal fluid, viruses, virus particles, protein, DNA, RNA or metabolites.

26. (canceled)

27. The method of claim 24, wherein said kinetic process is an electrokinetic process comprising a step of applying an electric field so as to induce said pressure gradients on said surface, optionally wherein said kinetic process is driven by one or more from group consisting of: electroosmosis, dielectrophoresis (DEP), and an electrostatic force, optionally, wherein said electroosmosis is induced charge electroosmosis (ICEO).

28.-29. (canceled)

30. The method of claim 24, further comprising one or more steps selected from: isolating one or more biological cells and constructing networks between cells of interest, on said configurable membrane.

31. The method of claim 24, further comprising one or more steps of performing a biological assay, optionally wherein:
(i) said biological assay is selected from: enzymatic assay, a binding assay, nucleic acid hybridization, Polymerase Chain Reaction (PCR), electrophoresis, liquid chromatography, cell activation, cell migration, cell separation, cell quantification, proteomic analysis, genomic analysis, DNA sequencing, microorganism detection, viral detection, DNA/RNA microarray, and immuno-assay;
(ii) said method further comprises a step of labeling said samples; and optionally wherein:
(iii) said method further comprises a step of probing said samples, optionally wherein said probing is achieved by using a photodetector, a photomultiplier tube (PMT), a conductivity detector, a point detector a radioactive detector, a camera, or any combination thereof, optionally said probing comprising tracing one or more optical signals.

32.-36. (canceled)

37. A device comprising:
a chamber comprising actuation medium;
a chemically patterned layer; and
a dynamically configurable layer,
wherein the chemically patterned layer is configured to induce a predetermined and variable pressure on at least a portion of said dynamically configurable layer, and wherein the configurable layer is configured to deform responsively to the pressure,
and wherein said device is configured to be operably linked to at least one electrode.

38. The device of claim 37, wherein the chemically patterned layer is deposited on at least a portion of said deformable plate, optionally wherein said chemically patterned layer comprises a light pattern electrode.

39. The device of claim 37, wherein the chemically patterned layer is deposited on at least a portion of the actuation medium, optionally wherein said chemically patterned layer comprises a light pattern electrode.

40. (canceled)

41. A method comprising the steps of:
(a) providing the device of claim 37.
(b) establishing a kinetic process on at least a portion of the dynamically configurable layer, so as to provide pressure distributions on a surface thereof, the deformation comprising one or more spatial gradient regions.
